(19) United States
(12) Patent Application Publication
(10) Pub. No.: US 2022/0206232 A1
(43) Pub. Date: Jun. 30, 2022

(54) LAYERED WAVEGUIDE FABRICATION BY ADDITIVE MANUFACTURING

(71) Applicant: Facebook Technologies, LLC, Menlo Park, CA (US)

(72) Inventors: Keren ZHANG, Woodinville, WA (US); Ankit VORA, Bothell, WA (US); Igor ABRAMSON, Duvall, WA (US); Nihar Ranjan MOHANTY, Snoqualmie, WA (US)

(21) Appl. No.: 17/551,543

(22) Filed: Dec. 15, 2021

Related U.S. Application Data
(60) Provisional application No. 63/132,137, filed on Dec. 30, 2020.

(51) Int. Cl. G02B 6/42; G02B 27/01

(52) U.S. Cl. CPC G02B 6/4207; G02B 6/4239; G02B 6/4212; G02B 27/0172

(57) ABSTRACT

A multi-layer waveguide display includes a base waveguide layer, one or more grating couplers on one or two surfaces of the base waveguide layer, an overcoat layer on each grating coupler of the one or more grating couplers and filling grating grooves of the grating coupler, and a first waveguide layer stack on a first side of the base waveguide layer. The first waveguide layer stack includes one or more polymer layers. Each of the one or more polymer layers is characterized by a respective refractive index lower than the refractive index of the base waveguide layer. Each polymer layer is formed in a plurality of process cycles, where each process cycle includes dispensing a two-dimensional array of droplets of a resin material to form a thin layer and cross-linking the thin layer to form a sublayer of the polymer layer.

### CROSS-REFERENCE TO RELATED APPLICATIONS

This application claims the benefit of and priority to U.S. Provisional Application No. 63/132,137, filed Dec. 30, 2020, entitled “LAYERED WAVEGUIDE FABRICATION BY ADDITIVE MANUFACTURING,” which is herein incorporated by reference in its entirety for all purposes.

### BACKGROUND

An artificial reality system, such as a head-mounted display (HMD) or heads-up display (HUD) system, generally includes a near-eye display configured to present content to a user via an electronic or optic display that is within, for example, about 10-20 mm in front of the user's eyes. The near-eye display may be in the form of, for example, a headset or a pair of glasses. The near-eye display may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment by, for example, seeing through transparent display glasses or lenses (often referred to as optical see-through).

One example of an optical see-through AR system may use a waveguide-based optical display, where light of projected images may be coupled into a waveguide (e.g., a transparent substrate), propagate within the waveguide, and be coupled out of the waveguide at multiple locations towards a user's eye. In some implementations, the light of the projected images may be coupled into or out of the waveguide using diffractive optical elements, such as gratings, which may allow light from the surrounding environment to pass through a see-through region of the waveguide to reach the user's eye without being diffracted.

### SUMMARY

This disclosure relates generally to artificial reality displays. More specifically, techniques disclosed herein relates to multi-layer waveguide-based artificial reality displays and methods of fabricating the same. Various inventive embodiments are described herein, including devices, systems, methods, materials, processes, and the like.

According to certain embodiments, a method of fabricating a multi-layer waveguide display may include obtaining a first waveguide layer including one or more grating couplers formed thereon, and forming a second waveguide layer on a first side of the first waveguide layer in a plurality of process cycles. Each grating coupler of the one or more grating couplers may include an overcoat layer that fills grating grooves of the grating coupler and is characterized by a refractive index different from a refractive index of the first waveguide layer. Each process cycle of the plurality of process cycles may include depositing a thin layer of a first resin material on the first waveguide layer, and cross-linking the thin layer of the first resin material to form a sublayer of the second waveguide layer. The first resin material may be characterized by a refractive index lower than the refractive index of the first waveguide layer.

In some embodiments, depositing the thin layer of the first resin material on the first waveguide layer may include dispensing a two-dimensional array of droplets of the first resin material on the first waveguide layer. In some embodiments, depositing the thin layer of the first resin material on the first waveguide layer may include depositing the thin layer of the first resin material on selected but not all regions of the first waveguide layer. Cross-linking the thin layer of the first resin material may include curing the thin layer of the first resin material by electromagnetic radiation (e.g., ultraviolet light) or thermal treatment. The thin layer of the first resin material may be characterized by a thickness equal to or less than 10 μm.

The first resin material may include an actinic light curable moiety, such as acrylate, epoxide, vinyl, thiols, allyls, vinylether, allylethers, epoxy acrylates, urethane acrylates, polyester acrylates, or a combination thereof. The first resin material further may also include a photoinitiator and/or nanoparticles of at least one of titanium oxide, zirconium oxide, hafnium oxide, tungsten oxide, zinc tellurium, gallium phosphide, or a combination thereof. The refractive index of the first resin material is between 1.45 and 2.0, such as between about 1.50 and 1.70. In some embodiments, the first resin material may have a density less than about 2 g/cm³, such as less than about 1.5 g/cm³ (e.g., about 1.25 g/cm³).

In some embodiments, the method may include, before forming the second waveguide layer on the first side of the first waveguide layer, forming an adhesion promoting layer on the first waveguide layer. Forming the adhesion promoting layer on the first waveguide layer may include, for example, inkjetting or spin coating a layer of epoxy acrylate, silane acrylate, silane epoxy, diacrylate, diepoxy, or a combination thereof on the first waveguide layer, or depositing (e.g., using PVD or evaporation) a layer of SiO₂ or another inorganic material on the first waveguide layer, where the adhesion promoting layer may be much thinner than the second waveguide layer.

In some embodiments, the method may include forming a third waveguide layer on the second waveguide layer in a second plurality of process cycles. Each process cycle of the second plurality of process cycles may include depositing, on the second waveguide layer, a thin layer of a second resin material that has a refractive index lower than the refractive index of the first resin material, and cross-linking the thin layer of the second resin material.

In some embodiments, the method may include forming a third waveguide layer on a second side of the first waveguide layer opposing the first side in a second plurality of process cycles. Each process cycle of the second plurality of process cycles may include depositing, on the second side of the first waveguide layer, a thin layer of a second resin material that has a refractive index lower than the refractive index of the first waveguide layer, and cross-linking the thin layer of the second resin material. The second resin material may be the same as or different from the first resin material.

In some embodiments, a root mean squared areal roughness of a surface of the second waveguide layer may be less than about 1 nm. An average thickness of the second waveguide layer may be greater than about 100 μm. A total thickness variation of the second waveguide layer may be less than about 1 μm. The one or more grating couplers may be on one or two surfaces of the first waveguide layer and include slanted or vertical surface-relief gratings.

According to certain embodiments, a multi-layer waveguide display may include a base waveguide layer, one or more grating couplers on one or two surfaces of the base waveguide layer, an overcoat layer on each grating coupler of the one or more grating couplers, and a first waveguide layer stack on a first side of the base waveguide layer. The overcoat layer may fill the grating grooves of the grating coupler and may have a refractive index different from a refractive index of the base waveguide layer. The first waveguide layer stack may include one or more polymer layers, where each of the one or more polymer layers may be characterized by a respective refractive index lower than the refractive index of the base waveguide layer.

In some embodiments, the first waveguide layer stack may be characterized by a refractive index profile that decreases with an increase in a distance of the first waveguide layer stack from the base waveguide layer. A thickness of each of the one or more polymer layers may be greater than about 100 μm. A total thickness variation of the first waveguide layer stack may be less than about 1 μm. A root mean squared areal roughness of a surface of the first waveguide layer stack may be less than about 1 nm. A refractive index of the first waveguide layer stack may be between about 1.45 and about 2.0, such as between about 1.5 and 1.7. A density of the first waveguide layer stack may be below 2 g/cm³, such as less than about 1.5 g/cm³ (e.g., about 1.25 g/cm³). The first waveguide layer stack may include acrylate, epoxide, vinyl, thiols, allyls, vinylether, allylethers, epoxy acrylates, urethane acrylates, polyester acrylates, or a combination thereof. The first waveguide layer stack may include nanoparticles dispersed in the one or more polymer layers. The nanoparticles may include nanoparticles of titanium oxide, zirconium oxide, hafnium oxide, tungsten oxide, zinc tellurium, gallium phosphide, or a combination thereof. In some embodiments, the first waveguide layer stack is on selected but not all regions of the base waveguide layer.

The one or more grating couplers may include slanted or vertical surface-relief gratings on one or two surfaces of the base waveguide layer. In some embodiments, the multi-layer waveguide display may include an antireflection layer on the first waveguide layer stack. The antireflection layer may include a periodic pillar structure. In some embodiments, the multi-layer waveguide display may include a second waveguide layer stack on a second side of the base waveguide layer opposing the first side, where the second waveguide layer stack may include a second set of one or more polymer layers, and each polymer layer of the second set of one or more polymer layers may be characterized by a respective refractive index lower than the refractive index of the base waveguide layer. In some embodiments, the second waveguide layer stack is characterized by a refractive index profile that decreases with an increase in a distance of the second waveguide layer stack from the base waveguide layer. In some embodiments, the multi-layer waveguide display may include an adhesion promoting layer between the base waveguide layer and the first waveguide layer stack, where the adhesion promoting layer may include a layer of epoxy acrylate, silane acrylate, silane epoxy, diacrylate, diepoxy, or a combination thereof, or a thin layer of SiO2 or another inorganic material. The adhesion promoting layer may have a thickness less than a few microns or less than about 1 μm.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 illustrates an example of an optical see-through augmented reality system including a waveguide display according to certain embodiments.

FIG. 5A illustrates an example of a near-eye display device including a waveguide display according to certain embodiments.

FIG. 5B illustrates an example of a near-eye display device including a waveguide display according to certain embodiments.

FIG. 6A illustrates an example of an optical see-through augmented reality system including a waveguide display and surface-relief gratings for exit pupil expansion according to certain embodiments.

FIG. 6B illustrates an example of an eyebox including two-dimensional replicated exit pupils according to certain embodiments.

FIG. 7 illustrates an example of a slanted grating in a waveguide display according to certain embodiments.

FIG. 8A illustrates an example of a waveguide display.

FIG. 8B illustrates an example of a multi-layer waveguide display according to certain embodiments.

FIG. 9A illustrates an example of a multi-layer waveguide display according to certain embodiments.

FIG. 9B illustrates another example of a multi-layer waveguide display according to certain embodiments.

FIGS. 10A-10F illustrate an example of a method of fabricating a multi-layer waveguide display according to certain embodiments.

FIG. 11 illustrates an example of a waveguide display including multiple waveguide layers and dual-side antireflection structures according to certain embodiments.

FIG. 12 is a flowchart illustrating an example of a process for fabricating a multi-layer waveguide display using an additive manufacturing process according to certain embodiments.

FIG. 13 is a simplified block diagram of an electronic system of an example of a near-eye display for implementing some of the examples disclosed herein.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Techniques disclosed herein relate generally to artificial reality display systems. More specifically, and without limitation, disclosed herein are multi-layer waveguide displays for augmented reality or mixed reality systems and the method of fabricating the multi-layer waveguide displays. Various inventive embodiments are described herein, including devices, systems, methods, materials, processes, and the like.

In an optical see-through waveguide display system, display light may be coupled into a waveguide by input couplers and then coupled out of the waveguide by output couplers, such as grating couplers, towards user's eyes. The waveguide and the couplers may be transparent to ambient light such that the user can view the ambient environment through the waveguide display. Due to the different diffraction angles and different diffraction efficiencies, display light from different fields of view or in different colors may not be uniformly coupled out of the waveguide towards user's eyes.

In some implementations, a multi-layer waveguide may be used to improve the uniformity of the display light from different fields of view or in different colors. The multi-layer waveguide may have a layer stack including multiple waveguide layers having different refractive indices and/or thicknesses. In some embodiments, the multiple waveguide layers in the layer stack may have the highest refractive index at the center of the layer stack, and the refractive index may decrease from the center towards both sides of the layer stack. In some embodiments, the refractive index of the multiple waveguide layers may decrease from one side toward the opposite side of the layer stack.

According to certain embodiments, the multi-layer waveguide may be made using inkjet 3-D printing techniques. During the inkjet 3-D printing, a large number of small drops of a resin material (referred to as an ink) may be deposited on a substrate having input and output gratings formed thereon. The substrate may include, for example, a wafer of glass, silicon, silicon nitride, silicon carbide, LiNbO₃, TiO₂, GaN, AlN, Chemical Vapor Deposition (CVD) diamond, or ZnS. The large number of small drops of the resin material may form a thin layer (e.g., with a thickness less than about 20 μm or less than about 10 μm), which may be cross-linked, for example, through electromagnetic radiation (e.g., ultraviolet light curing) or thermal treatment. Another thin layer of the resin material may then be deposited on the cross-linked thin layer and cross-linked, until a desired total thickness of a waveguide layer is achieved. Another waveguide layer having a different (e.g., lower) refractive index may be similarly printed on the previously printed waveguide layer that may have a higher refractive index. Waveguide layers may be printed on an opposite side of the substrate in similar manners.

In some embodiments, the materials (inks) used for the 3-D printing may include a base resin that includes at least one actinic light curable moiety of acrylate, epoxide, vinyl, thiols, allyls, vinylether, allylethers, epoxy acrylates, urethane acrylates, polyester acrylates, or a combination thereof. The materials used for the 3-D printing may also include a photoinitiator, such as a photo radical generator (PRG) or a photo acid generator. The materials can be tuned to have the desired refractive index. For example, high-index nanoparticles may be added to the resin material to tune the refractive index of the resin material. The nanoparticles used to tune the refractive index of the resin material may include, for example, metal oxides such as titanium oxide, zirconium oxide, hafnium oxide, tungsten oxide, zinc tellurium, gallium phosphide, a derivative of any of the preceding materials, or any combination of these materials.

Using the techniques disclosed herein, transparent low index layers each with a thickness of about 10 microns to about a few hundred microns, low total thickness variation (TTV), and low surface roughness can be deposited on selected areas of interest, such as an entire surface of the base substrate or only on top of some functional devices (e.g., the output gratings). The thicknesses and thickness variations of the layers may be more precisely controlled. The process temperature can be below 250° C., such as room temperatures. As such, the bowing of the wafer may be low. Only one dicing step may be needed to form individual devices from a base substrate. There is no need to dice both the base substrate and additional substrates/layers and then bond them. The materials used for the 3-D printing can have a lower density (e.g., about 1.25 g/cm³) than, for example, the SiC substrate (e.g., about 3.21 g/cm³), fused silica (e.g., about 2.17 g/cm³), or other substrate materials. Thus, the waveguide display may have a lighter weight. The materials used for the printing can be tuned to have the desired refractive index. For example, high-index nanoparticles may be added to the resin material to tune the refractive index of the resin material, for example, from about 1.45 or lower to about 2.0 or higher, such as between about 1.5 and about 1.8.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

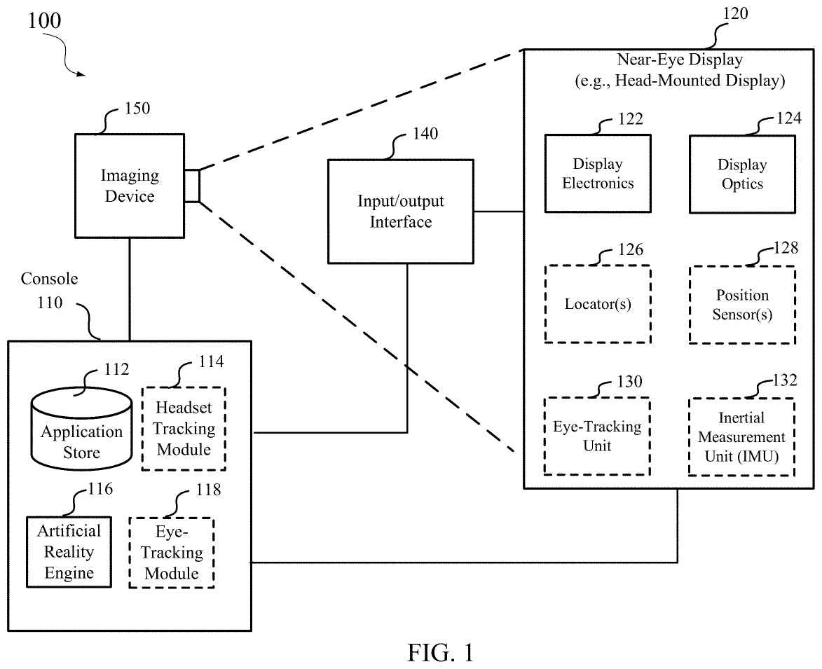

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

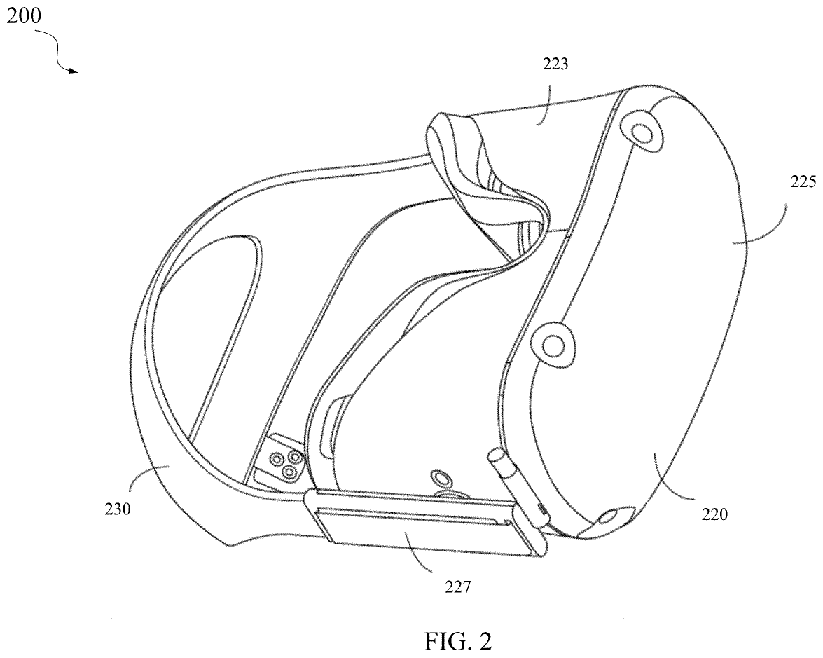

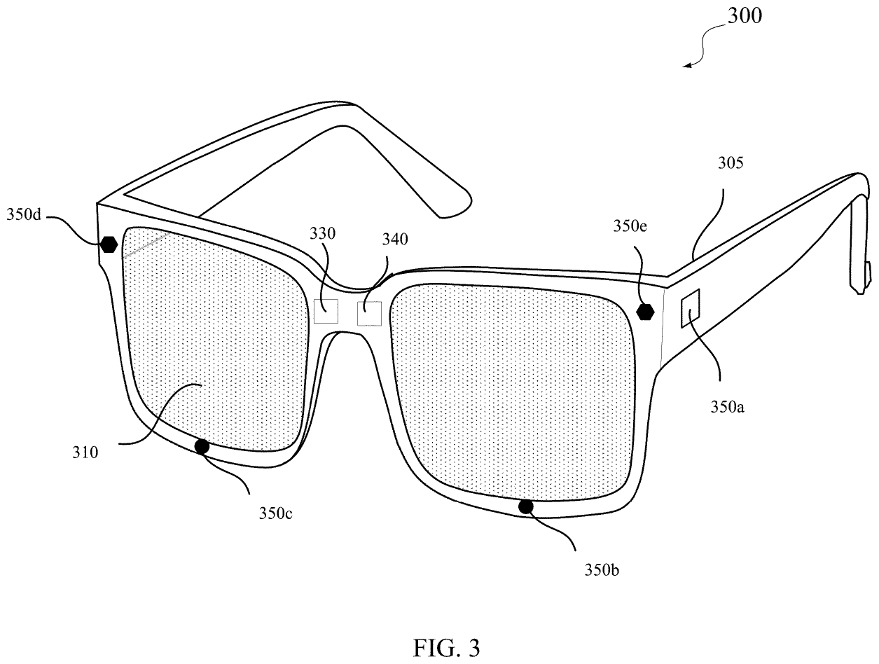

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, or sound) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an antireflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be an LED, a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 10 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, or aperture).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 100 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking module 114, an artificial reality engine 116, and an eye-tracking module 118. Some embodiments of console 110 may include different or additional modules than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the modules of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking module 114 may track movements of near-eye display 120 using slow calibration information from external imaging device 150. For example, headset tracking module 114 may determine positions of a reference point of near-eye display 120 using observed locators from the slow calibration information and a model of near-eye display 120. Headset tracking module 114 may also determine positions of a reference point of near-eye display 120 using position information from the fast calibration information. Additionally, in some embodiments, headset tracking module 114 may use portions of the fast calibration information, the slow calibration information, or any combination thereof, to predict a future location of near-eye display 120. Headset tracking module 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking module 114. Artificial reality engine 116 may also receive estimated eye position and orientation information from eye-tracking module 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking module 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking module 118 to determine the eye's orientation more accurately.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 200 may include two eyebox regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, or ultra-violet light), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. Camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

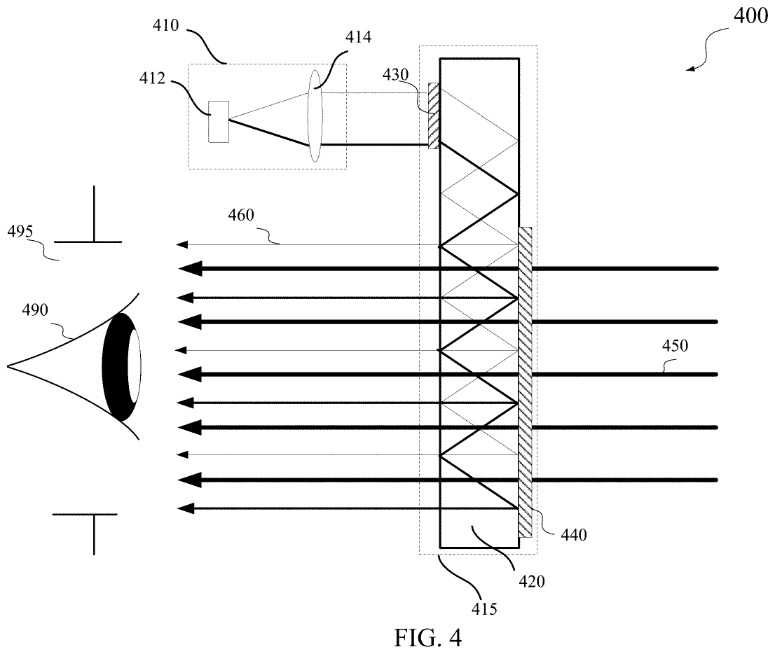

FIG. 4 illustrates an example of an optical see-through augmented reality system 400 including a waveguide display according to certain embodiments. Augmented reality system 400 may include a projector 410 and a combiner 415. Projector 410 may include a light source or image source 412 and projector optics 414. In some embodiments, light source or image source 412 may include one or more micro-LED devices described above. In some embodiments, image source 412 may include a plurality of pixels that displays virtual objects, such as an LCD display panel or an LED display panel. In some embodiments, image source 412 may include a light source that generates coherent or partially coherent light. For example, image source 412 may include a laser diode, a vertical cavity surface emitting laser, an LED, and/or a micro-LED described above. In some embodiments, image source 412 may include a plurality of light sources (e.g., an array of micro-LEDs described above), each emitting a monochromatic image light corresponding to a primary color (e.g., red, green, or blue). In some embodiments, image source 412 may include three two-dimensional arrays of micro-LEDs, where each two-dimensional array of micro-LEDs may include micro-LEDs configured to emit light of a primary color (e.g., red, green, or blue). In some embodiments, image source 412 may include an optical pattern generator, such as a spatial light modulator. Projector optics 414 may include one or more optical components that can condition the light from image source 412, such as expanding, collimating, scanning, or projecting light from image source 412 to combiner 415. The one or more optical components may include, for example, one or more lenses, liquid lenses, mirrors, apertures, and/or gratings. For example, in some embodiments, image source 412 may include one or more one-dimensional arrays or elongated two-dimensional arrays of micro-LEDs, and projector optics 414 may include one or more one-dimensional scanners (e.g., micro-mirrors or prisms) configured to scan the one-dimensional arrays or elongated two-dimensional arrays of micro-LEDs to generate image frames. In some embodiments, projector optics 414 may include a liquid lens (e.g., a liquid crystal lens) with a plurality of electrodes that allows scanning of the light from image source 412.

Combiner 415 may include an input coupler 430 for coupling light from projector 410 into a substrate 420 of combiner 415. Combiner 415 may transmit at least 50% of light in a first wavelength range and reflect at least 25% of light in a second wavelength range. For example, the first wavelength range may be visible light from about 400 nm to about 650 nm, and the second wavelength range may be in the infrared band, for example, from about 800 nm to about 1000 nm. Input coupler 430 may include a volume holographic grating, a diffractive optical element (DOE) (e.g., a surface-relief grating), a slanted surface of substrate 420, or a refractive coupler (e.g., a wedge or a prism). For example, input coupler 430 may include a reflective volume Bragg grating or a transmissive volume Bragg grating. Input coupler 430 may have a coupling efficiency of greater than 30%, 50%, 75%, 90%, or higher for visible light. Light coupled into substrate 420 may propagate within substrate 420 through, for example, total internal reflection (TIR). Substrate 420 may be in the form of a lens of a pair of eyeglasses. Substrate 420 may have a flat or a curved surface, and may include one or more types of dielectric or semiconductor materials, such as glass, quartz, plastic, polymer, poly(methyl methacrylate) (PMMA), crystal, silicon, SiN, silicon carbide, ceramic, or the like. A thickness of the substrate may range from, for example, less than about 1 mm to about 10 mm or more. Substrate 420 may be transparent to visible light.

Substrate 420 may include or may be coupled to a plurality of output couplers 440, each configured to extract at least a portion of the light guided by and propagating within substrate 420 from substrate 420, and direct extracted light 460 to an eyebox 495 where an eye 490 of the user of augmented reality system 400 may be located when augmented reality system 400 is in use. The plurality of output couplers 440 may replicate the exit pupil to increase the size of eyebox 495 such that the displayed image is visible in a larger area. As input coupler 430, output couplers 440 may include grating couplers (e.g., volume holographic gratings or surface-relief gratings), other diffraction optical elements, or prisms. For example, output couplers 440 may include reflective volume Bragg gratings or transmissive volume Bragg gratings. Output couplers 440 may have different coupling (e.g., diffraction) efficiencies at different locations. Substrate 420 may also allow light 450 from the environment in front of combiner 415 to pass through with little or no loss. Output couplers 440 may also allow light 450 to pass through with little loss. For example, in some implementations, output couplers 440 may have a very low diffraction efficiency for light 450 such that light 450 may be refracted or otherwise pass through output couplers 440 with little loss, and thus may have a higher intensity than extracted light 460. In some implementations, output couplers 440 may have a high diffraction efficiency for light 450 and may diffract light 450 in certain desired directions (i.e., diffraction angles) with little loss. As a result, the user may be able to view combined images of the environment in front of combiner 415 and images of virtual objects projected by projector 410.

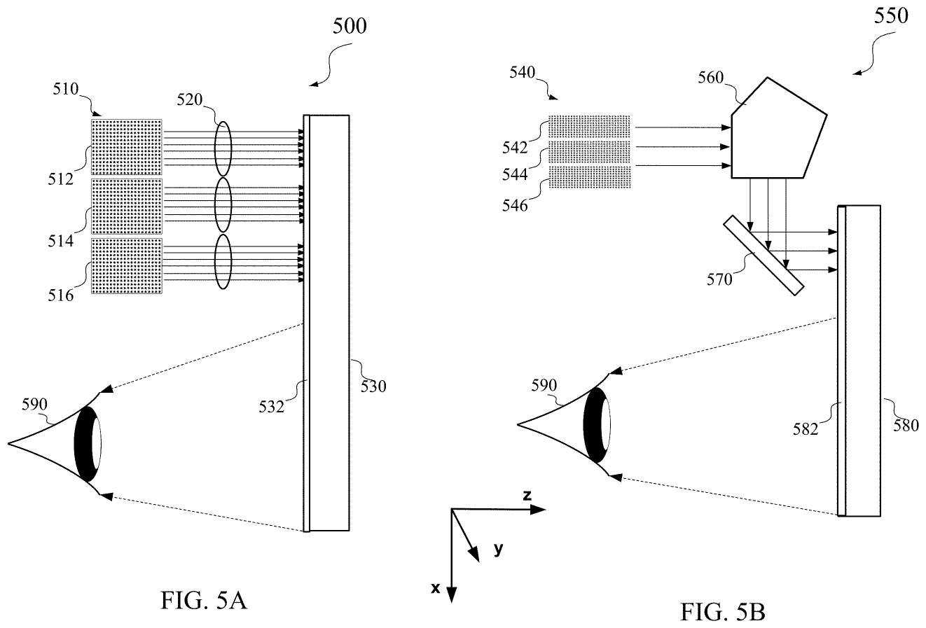

FIG. 5A illustrates an example of a near-eye display (NED) device 500 including a waveguide display 530 according to certain embodiments. NED device 500 may be an example of near-eye display 120, augmented reality system 400, or another type of display device. NED device 500 may include a light source 510, projection optics 520, and waveguide display 530. Light source 510 may include multiple panels of light emitters for different colors, such as a panel of red light emitters 512, a panel of green light emitters 514, and a panel of blue light emitters 516. The red light emitters 512 are organized into an array; the green light emitters 514 are organized into an array; and the blue light emitters 516 are organized into an array. The dimensions and pitches of light emitters in light source 510 may be small. For example, each light emitter may have a diameter less than 2 μm (e.g., about 1.2 μm) and the pitch may be less than 2 μm (e.g., about 1.5 μm). As such, the number of light emitters in each red light emitters 512, green light emitters 514, and blue light emitters 516 can be equal to or greater than the number of pixels in a display image, such as 960×720, 1280×720, 1440×1080, 1920×1080, 2160×1080, or 2560×1080 pixels. Thus, a display image may be generated simultaneously by light source 510. A scanning element may not be used in NED device 500.

Before reaching waveguide display 530, the light emitted by light source 510 may be conditioned by projection optics 520, which may include a lens array. Projection optics 520 may collimate or focus the light emitted by light source 510 to waveguide display 530, which may include a coupler 532 for coupling the light emitted by light source 510 into waveguide display 530. The light coupled into waveguide display 530 may propagate within waveguide display 530 through, for example, total internal reflection as described above with respect to FIG. 4. Coupler 532 may also couple portions of the light propagating within waveguide display 530 out of waveguide display 530 and towards user's eye 590.

FIG. 5B illustrates an example of a near-eye display (NED) device 550 including a waveguide display 580 according to certain embodiments. In some embodiments, NED device 550 may use a scanning mirror 570 to project light from a light source 540 to an image field where a user's eye 590 may be located. NED device 550 may be an example of near-eye display 120, augmented reality system 400, or another type of display device. Light source 540 may include one or more rows or one or more columns of light emitters of different colors, such as multiple rows of red light emitters 542, multiple rows of green light emitters 544, and multiple rows of blue light emitters 546. For example, red light emitters 542, green light emitters 544, and blue light emitters 546 may each include N rows, each row including, for example, 2560 light emitters (pixels). The red light emitters 542 are organized into an array; the green light emitters 544 are organized into an array; and the blue light emitters 546 are organized into an array. In some embodiments, light source 540 may include a single line of light emitters for each color. In some embodiments, light source 540 may include multiple columns of light emitters for each of red, green, and blue colors, where each column may include, for example, 1080 light emitters. In some embodiments, the dimensions and/or pitches of the light emitters in light source 540 may be relatively large (e.g., about 3-5 μm) and thus light source 540 may not include sufficient light emitters for simultaneously generating a full display image. For example, the number of light emitters for a single color may be fewer than the number of pixels (e.g., 2560×1080 pixels) in a display image. The light emitted by light source 540 may be a set of collimated or diverging beams of light.

Before reaching scanning mirror 570, the light emitted by light source 540 may be conditioned by various optical devices, such as collimating lenses or a freeform optical element 560. Freeform optical element 560 may include, for example, a multi-facet prism or another light folding element that may direct the light emitted by light source 540 towards scanning mirror 570, such as changing the propagation direction of the light emitted by light source 540 by, for example, about 90° or larger. In some embodiments, freeform optical element 560 may be rotatable to scan the light. Scanning mirror 570 and/or freeform optical element 560 may reflect and project the light emitted by light source 540 to waveguide display 580, which may include a coupler 582 for coupling the light emitted by light source 540 into waveguide display 580. The light coupled into waveguide display 580 may propagate within waveguide display 580 through, for example, total internal reflection as described above with respect to FIG. 4. Coupler 582 may also couple portions of the light propagating within waveguide display 580 out of waveguide display 580 and towards user's eye 590.

Scanning mirror 570 may include a microelectromechanical system (MEMS) mirror or any other suitable mirrors. Scanning mirror 570 may rotate to scan in one or two dimensions. As scanning mirror 570 rotates, the light emitted by light source 540 may be directed to a different area of waveguide display 580 such that a full display image may be projected onto waveguide display 580 and directed to user's eye 590 by waveguide display 580 in each scanning cycle. For example, in embodiments where light source 540 includes light emitters for all pixels in one or more rows or columns, scanning mirror 570 may be rotated in the column or row direction (e.g., x or y direction) to scan an image. In embodiments where light source 540 includes light emitters for some but not all pixels in one or more rows or columns, scanning mirror 570 may be rotated in both the row and column directions (e.g., both x and y directions) to project a display image (e.g., using a raster-type scanning pattern).

NED device 550 may operate in predefined display periods. A display period (e.g., display cycle) may refer to a duration of time in which a full image is scanned or projected. For example, a display period may be a reciprocal of the desired frame rate. In NED device 550 that includes scanning mirror 570, the display period may also be referred to as a scanning period or scanning cycle. The light generation by light source 540 may be synchronized with the rotation of scanning mirror 570. For example, each scanning cycle may include multiple scanning steps, where light source 540 may generate a different light pattern in each respective scanning step.

In each scanning cycle, as scanning mirror 570 rotates, a display image may be projected onto waveguide display 580 and user's eye 590. The actual color value and light intensity (e.g., brightness) of a given pixel location of the display image may be an average of the light beams of the three colors (e.g., red, green, and blue) illuminating the pixel location during the scanning period. After completing a scanning period, scanning mirror 570 may revert back to the initial position to project light for the first few rows of the next display image or may rotate in a reverse direction or scan pattern to project light for the next display image, where a new set of driving signals may be fed to light source 540. The same process may be repeated as scanning mirror 570 rotates in each scanning cycle. As such, different images may be projected to user's eye 590 in different scanning cycles.

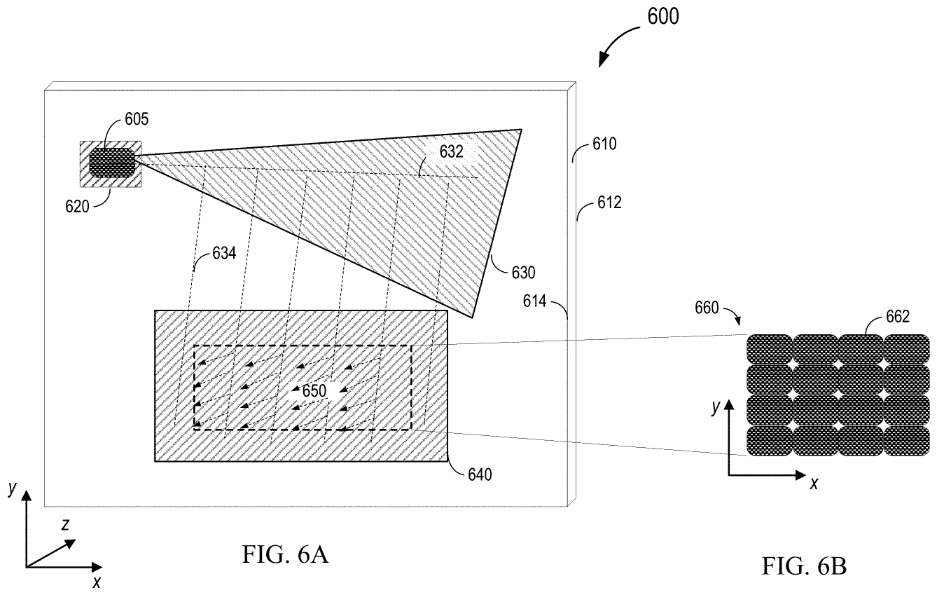

FIG. 6A illustrates an example of an optical see-through augmented reality system including a waveguide display 600 and surface-relief gratings for exit pupil expansion according to certain embodiments. Waveguide display 600 may include a substrate 610 (e.g., a waveguide), which may be similar to substrate 420. Substrate 610 may be transparent to visible light and may include, for example, a glass, quartz, plastic, polymer, PMMA, ceramic, Si₃N₄, or crystal substrate. Substrate 610 may be a flat substrate or a curved substrate. Substrate 610 may include a first surface 612 and a second surface 614. Display light may be coupled into substrate 610 by an input coupler 620, and may be reflected by first surface 612 and second surface 614 through total internal reflection, such that the display light may propagate within substrate 610. Input coupler 620 may include a grating, a refractive coupler (e.g., a wedge or a prism), or a reflective coupler (e.g., a reflective surface having a slant angle with respect to substrate 610). For example, in one embodiment, input coupler 620 may include a prism that may couple display light of different colors into substrate 610 at a same refraction angle. In another example, input coupler 620 may include a grating coupler that may diffract light of different colors into substrate 610 at different directions. Input coupler 620 may have a coupling efficiency of greater than 10%, 20%, 30%, 50%, 75%, 90%, or higher for visible light.

Waveguide display 600 may also include a first output grating 630 and a second output grating 640 positioned on one or two surfaces (e.g., first surface 612 and second surface 614) of substrate 610 for expanding incident display light beam in two dimensions in order to fill an eyebox with the display light. First output grating 630 and second output grating 640 may include, for example, surface relief gratings or holographic gratings, such as volume Bragg gratings. First output grating 630 may be configured to expand at least a portion of the display light beam along one direction, such as approximately in the x direction. Display light coupled into substrate 610 may propagate in a direction shown by a line 632. While the display light propagates within substrate 610 along a direction shown by line 632, a portion of the display light may be diffracted by a region of first output grating 630 towards second output grating 640 as shown by a line 634 each time the display light propagating within substrate 610 reaches first output grating 630. Second output grating 640 may then expand the display light from first output grating 630 in a different direction (e.g., approximately in the y direction) by diffracting a portion of the display light from an exit region 650 to the eyebox each time the display light propagating within substrate 610 reaches second output grating 640.

FIG. 6B illustrates an example of an eyebox including two-dimensional replicated exit pupils. FIG. 6B shows that a single input pupil 605 may be replicated by first output grating 630 and second output grating 640 to form an aggregated exit pupil 660 that includes a two-dimensional array of individual exit pupils 662. For example, the exit pupil may be replicated in approximately the x direction by first output grating 630 and in approximately the y direction by second output grating 640. As described above, output light from individual exit pupils 662 and propagating in a same direction may be focused onto a same location in the retina of the user's eye. Thus, a single image may be formed by the user's eye from the output light in the two-dimensional array of individual exit pupils 662.

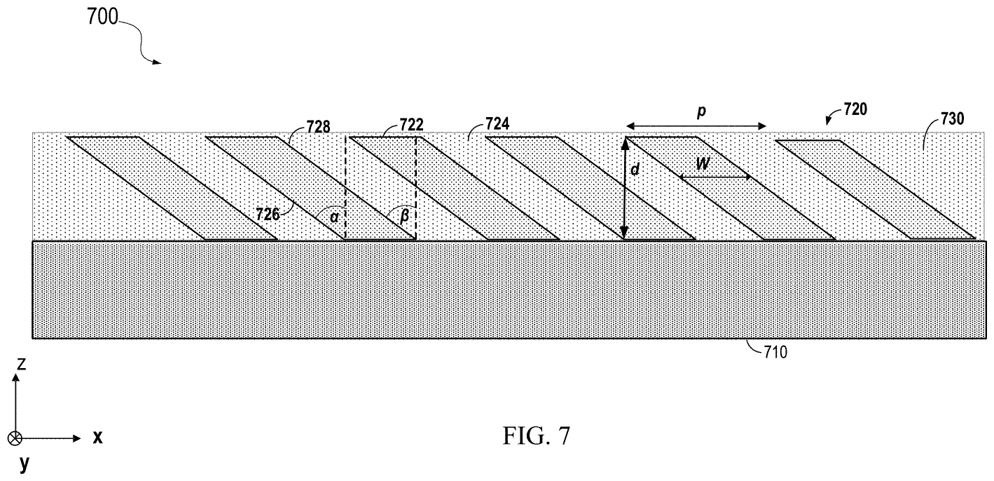

FIG. 7 illustrates an example of a slanted grating 720 in a waveguide display 700 according to certain embodiments. Slanted grating 720 may be an example of input coupler 430, output couplers 440, input coupler 620, first output grating 630, and second output grating 640. Slanted grating 720 may be formed on a waveguide 710, such as substrate 420, or substrate 610. Slanted grating 720 may act as a grating coupler for couple light into or out of waveguide 710. In some embodiments, slanted grating 720 may include a one-dimensional periodic structure with a period p. For example, slanted grating 720 may include a plurality of ridges 722 and grooves 724 between ridges 722. Each period of slanted grating 720 may include a ridge 722 and a groove 724, which may be an air gap or a region filled with a material with a refractive index n_{g2}. The ratio between the width d of a ridge 722 and the grating period p may be referred to as duty cycle. Slanted grating 720 may have a duty cycle ranging, for example, from about 10% to about 90% or greater. In some embodiments, the duty cycle may vary from period to period. In some embodiments, the period p of the slanted grating may vary from one area to another on slanted grating 720, or may vary from one period to another (i.e., chirped) on slanted grating 720. In some embodiments, the heights of ridges 722 or the depths of grooves 724 may vary from one area to another on slanted grating 720, or may vary from one period to another on slanted grating 720. In some embodiments, slanted grating 720 may include a two-dimensional grating. In some embodiments, the period p, the duty cycle, the heights of ridges 722, and/or the depths of grooves 724 of slanted grating 720 may vary along the x direction, the y direction, or both.

Ridges 722 may be made of a material with a refractive index of n_{g1}, such as silicon containing materials (e.g., SiO₂, Si₃N₄, SiC, SiOₓN_{y}, or amorphous silicon), organic materials (e.g., spin on carbon (SOC) or amorphous carbon layer (ACL) or diamond like carbon (DLC)), or inorganic metal oxide layers (e.g., TiOₓ, AlOₓ, TaOₓ, or HfOₓ). Each ridge 722 may include a leading edge 726 with a slant angel α and a trailing edge 728 with a slant angle β. In some embodiments, leading edge 726 and training edge 728 of each ridge 722 may be parallel to each other. In other words, slant angle α is approximately equal to slant angle β. In some embodiments, slant angle α may be different from slant angle β. In some embodiments, slant angle α may be approximately equal to slant angle β. For example, the difference between slant angle α and slant angle β may be less than 20%, 10%, 5%, 1%, or less. In some embodiments, slant angle α and slant angle β may range from, for example, about 30° or less to about 70% or larger.

In some implementations, grooves 724 between the ridges 722 may be over-coated or filled with an overcoat layer 730. Overcoat layer 730 may include a material having a refractive index n_{g2} higher or lower than the refractive index of the material of ridges 722. For example, in some embodiments, a high refractive index material, such as Hafnia, Titania, Tantalum oxide, Tungsten oxide, Zirconium oxide, Gallium sulfide, Gallium nitride, Gallium phosphide, silicon, and a high refractive index polymer, may be used to fill grooves 724. In some embodiments, a low refractive index material, such as silicon oxide, alumina, porous silica, or fluorinated low index monomer (or polymer), may be used to fill grooves 724. As a result, the difference between the refractive index of the ridges and the refractive index of the grooves may be greater than 0.1, 0.2, 0.3, 0.5, 1.0, or higher. In some embodiments, the top surface of overcoat layer 730 may align with the top surfaces of ridges 722. In some embodiments, the top surface of overcoat layer 730 may be above the top surfaces of ridges 722.

Slanted grating 720, as a diffractive optical element, may be wavelength dependent. For example, due to the different wavelength λ, light of different colors incident at a same incident angle may be diffracted at diffraction angles for the same diffraction order to satisfy the grating equation. Light of a same color from different fields of view may also be diffracted at different angles to satisfy the grating equation.

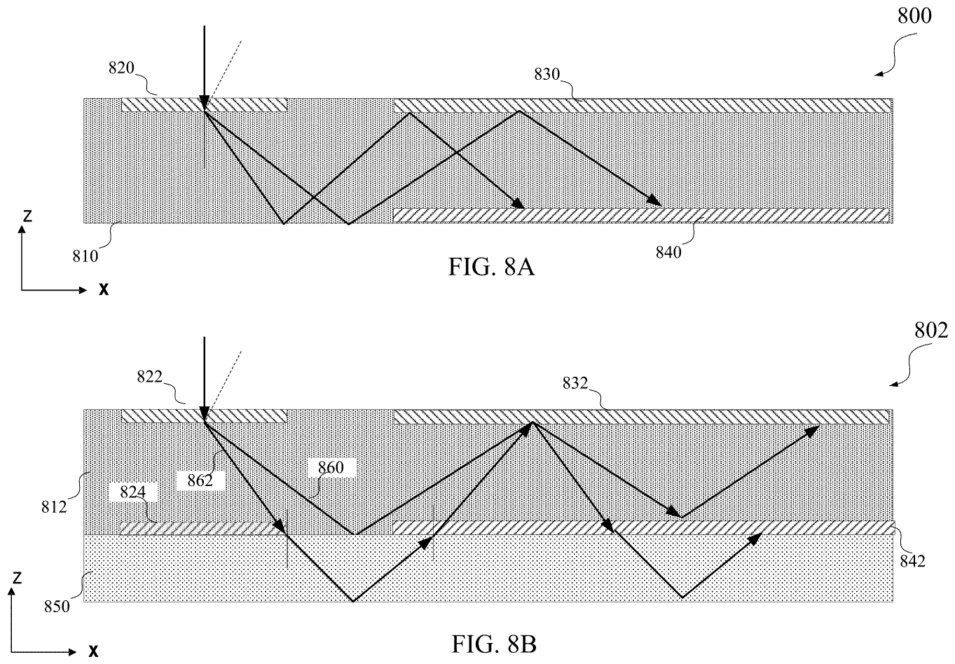

FIG. 8A illustrates an example of a waveguide display 800. Waveguide display 800 may include a substrate 810, which be similar to substrate 420, substrate 610, or waveguide 710. Substrate 810 may include, for example, glass, silicon, silicon nitride, silicon carbide, LiNbO₃, TiO₂, GaN, AlN, SiC, CVD diamond, ZnS, or any other suitable material. An input grating 820 and one or more output gratings 830 and 840 may be etched in substrate 810 or in a grating material layer formed on substrate 810. Input grating 820 and output gratings 830 and 840 may include slanted or vertical surface-relief gratings, and may include an overcoat layer filling the grating grooves as described above. Output gratings 830 and 840 may be etched on opposite surfaces of substrate 810. In some embodiments, only one output grating 830 or 840 may be used. As described above with respect to, for example, FIGS. 4 and 6A, input grating 820 may couple display light of different colors (e.g., red, green, and blue) from different view angles (or within different fields of view (FOVs)) into substrate 810, which may guide the in-coupled display light through total internal reflection. A portion of the in-coupled display light propagating within substrate 810 may be coupled out of substrate 810 towards an eyebox of waveguide display 800 by output grating 830 or 840 each time the in-coupled display light reaches output grating 830 or 840.

As described above, to satisfy the grating equation, a diffraction grating may diffract incident light of different colors (wavelengths) and/or from different view angles to different diffraction angles. For example, in the example illustrated in FIG. 8A, two light beams having different colors (e.g., red and blue) and the same incidence angle (e.g., about 0°) may be diffracted by input grating 820 to different directions within substrate 810. More specifically, the light beam having a shorter wavelength (e.g., blue light) may have a smaller diffraction angle. Two light beams having the same color but different incidence angles may also be diffracted by input grating 820 to two different directions within substrate 810. Due to the different propagation directions, the two in-coupled light beams may reach the surfaces of substrate 810 and be diffracted out of substrate 810 after propagating different distances in the x direction. A light beam having a smaller angle with respect to the surface-normal direction of substrate 810 may reach output grating 830 or 840 for a larger number of times than a light beam having a larger angle with respect to the surface-normal direction of substrate 810. In addition, a grating may not have a flat diffraction efficiency for incident light of different colors or different incidence angle. For these reasons, display light of different colors or from different FOVs may be directed to the eyebox at different densities, and may also form ghost images on the retina of user's eyes.

According to certain embodiments, to reduce the ghost images and improve the uniformity of the display for light of all colors and from all FOVs, a multi-layer waveguide may be used. The multi-layer waveguide may include multiple waveguide layers having appropriate refractive indices and thicknesses in a layer stack. In some embodiments, the multiple waveguide layers in the layer stack may have the highest refractive index at the center of the layer stack, and the refractive indices of the multiple waveguide layers may decrease from the center towards the two opposite sides of the layer stack. In some embodiments, the refractive indices of the multiple waveguide layers may decrease from one side toward the opposite side of the layer stack.

FIG. 8B illustrates an example of a multi-layer waveguide display 802 according to certain embodiments. Multi-layer waveguide display 802 may include a substrate 812, an input grating 822, and one or more output gratings 832 and 842, which may be similar to substrate 810, input grating 820, and one or more output gratings 830 and 840, respectively. Input gratings 822 and 824 and output gratings 832 and 842 may be vertical or slanted surface-relief gratings formed in substrate 812 or a grating material layer on substrate 812, and may include an overcoat layer filling the grating grooves as described above with respect to FIG. 7. Multi-layer waveguide display 802 may also include a second waveguide layer 850, which may be a thin layer (e.g., a few hundred micrometers, such as between about 100 μm and about 600 μm) of a transparent material having a lower refractive index than the refractive index of substrate 812. For example, the difference between the refractive index of substrate 812 and the refractive index of second waveguide layer 850 may be about 0.01, 0.02, 0.05, 0.1, 0.2, 0.25, 0.3, or larger.

In the example shown in FIG. 8B, a first light beam 860 (e.g., having a longer wavelength or from a larger view angle) may be coupled into substrate 812 by input grating 822 and may propagate within substrate 812 with a large angle with respect to a surface-normal direction of substrate 812. Therefore, first light beam 860 may be reflected at the interface between substrate 812 and second waveguide layer 850 through total internal reflection, due to the large incidence angle and the large difference between the refractive indices of substrate 812 and second waveguide layer 850. A second light beam 862 (e.g., having a shorter wavelength and/or from a smaller view angle) may be coupled into substrate 812 by input grating 822 and may propagate within substrate 812 with a smaller angle with respect to the surface-normal direction of substrate 812. Therefore, second light beam 862 may not be reflected at the interface between substrate 812 and second waveguide layer 850 through total internal reflection, because the incidence angle may be smaller than the critical angle at the interface. Thus, second light beam 862 may instead be refracted at the interface with a larger refraction angle into second waveguide layer 850, and may then be reflected at the bottom surface of second waveguide layer 850 through total internal reflection due to the increased incidence angle and the larger difference (e.g., about 0.5) between the refractive indices of second waveguide layer 850 and air. Therefore, even though second light beam 862 may have a smaller propagation angle with respect to the surface-normal direction of substrate 812 than first light beam 860, second light beam 862 may travel a longer distance in the z direction before being reflected through total internal reflection, and thus may travel a similar distance in the x direction as first light beam 860 before being reflected through total internal reflection. In this way, first light beam 860 and second light beam 862 may be diffracted by output grating 832 or 842 at about the same locations (or same interval) and for about the same number of times. The thicknesses and refractive indices of substrate 812 and second waveguide layer 850 may be selected based on the desired performance.

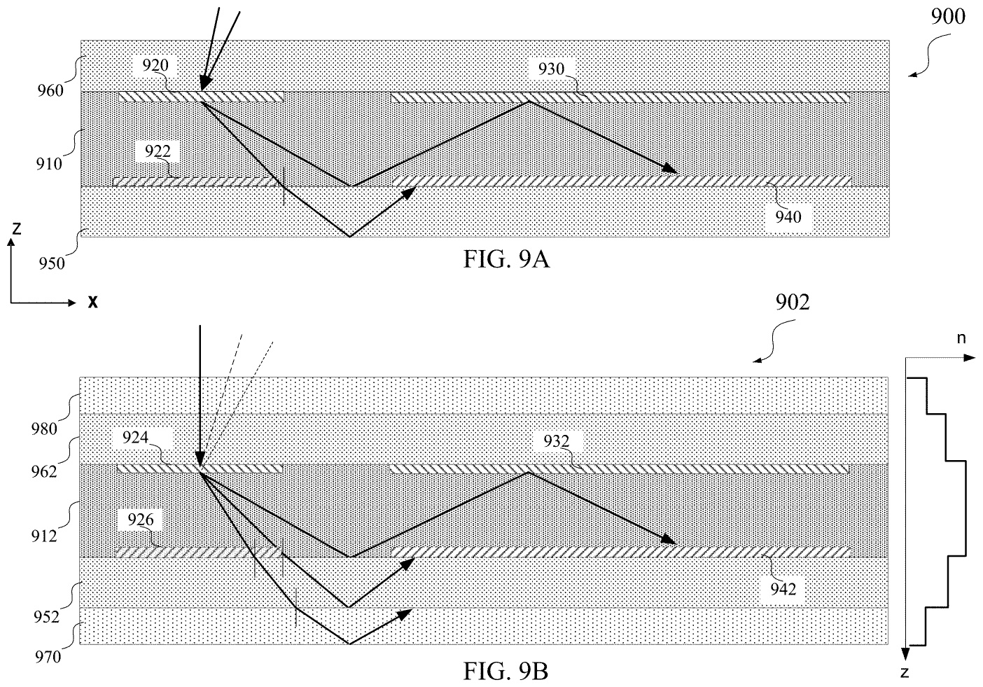

FIG. 9A illustrates an example of a multi-layer waveguide display 900 according to certain embodiments. Multi-layer waveguide display 900 may include a first waveguide layer 910 that includes one or more input gratings 920 and 922 and one or more output gratings 930 and 940 formed thereon as in waveguide display 800 and multi-layer waveguide display 802 described above. First waveguide layer 910 may include, for example, glass, silicon, silicon nitride, silicon carbide, LiNbO₃, TiO₂, GaN, AlN, CVD diamond, ZnS, and the like. Input gratings 920 and 922 and output gratings 930 and 940 may be slanted or vertical surface-relief gratings and may include an overcoat layer filling the grating grooves. In some embodiments, one or more of input gratings 920 and 922 and output gratings 930 and 940 may each have a variable grating period, a variable duty cycle, a variable slant angle, and/or a variable etch depth. In some embodiments, one or more of the input gratings and output gratings may each include a two-dimensional grating that has a variable grating period, a variable duty cycle, a variable slant angle, and/or a variable etch depth along two directions of the two-dimensional grating.

Multi-layer waveguide display 900 may include a second waveguide layer 950 and a third waveguide layer 960 on opposing sides of first waveguide layer 910. Second waveguide layer 950 and third waveguide layer 960 may each be a thin layer (e.g., a few hundred micrometers, such as between about 100 μm and about 600 μm) of a transparent material having a lower refractive index than the refractive index of first waveguide layer 910. For example, the difference between the refractive index of first waveguide layer 910 and the refractive index of second waveguide layer 950 or third waveguide layer 960 may be about 0.01, 0.02, 0.05, 0.1, 0.2, 0.25, 0.3, or larger. Multi-layer waveguide display 900 may achieve a more uniform replication of light having different colors and/or from different FOVs as described above with respect to FIG. 6B and FIG. 8B. The thicknesses and the refractive indices of first waveguide layer 910, second waveguide layer 950, and third waveguide layer 960 may be selected based on the desired performance.

FIG. 9B illustrates another example of a multi-layer waveguide display 902 according to certain embodiments. Multi-layer waveguide display 902 may include a first waveguide layer 912 that includes one or more input gratings 924 and 926 and one or two output gratings 932 and 942 formed thereon as in waveguide display 800 and multi-layer waveguide display 802 or 900 described above. First waveguide layer 912 may include, for example, glass, silicon, silicon nitride, silicon carbide, LiNbO₃, TiO₂, GaN, AlN, CVD diamond, ZnS, and the like. Input gratings 924 and 926 and output gratings 932 and 942 may be slanted or vertical surface-relief gratings and may include an overcoat layer filling the grating grooves as described above with respect to, for example, FIG. 7. In some embodiments, one or more of input gratings 924 and 926 and output gratings 932 and 942 may each have a variable grating period, a variable duty cycle, a variable slant angle, and/or a variable etch depth. In some embodiments, one or more of the input gratings and output gratings may each include a two-dimensional grating that has a variable grating period, a variable duty cycle, a variable slant angle, and/or a variable etch depth along two directions of the two-dimensional grating.

Multi-layer waveguide display 902 may include a second waveguide layer 952 and a third waveguide layer 962 on opposing sides of first waveguide layer 912. Second waveguide layer 952 and third waveguide layer 962 may each be a thin layer (e.g., a few hundred micrometers, such as between about 100 μm and about 600 μm) of a transparent material having a lower refractive index than the refractive index of first waveguide layer 912. For example, the difference between the refractive index of first waveguide layer 912 and the refractive index of second waveguide layer 952 or third waveguide layer 962 may be about 0.01, 0.02, 0.05, 0.1, 0.2, 0.25, 0.3, or larger. Second waveguide layer 952 and third waveguide layer 962 may have a same refractive index or different refractive indices.

In addition, a fourth waveguide layer 970 may be formed on second waveguide layer 952, and a fifth waveguide layer 980 may be formed on third waveguide layer 962. Fourth waveguide layer 970 and fifth waveguide layer 980 may each be a thin layer (e.g., a few hundred micrometers, such as between about 100 μm and about 600 μm) of a transparent material having a lower refractive index than the refractive indices of second waveguide layer 952 and third waveguide layer 962, respectively. For example, the difference between the refractive index of second waveguide layer 952 and the refractive index of fourth waveguide layer 970 and the difference between the refractive index of third waveguide layer 962 and the refractive index of fifth waveguide layer 980 may be about 0.01, 0.02, 0.05, 0.1, 0.2, 0.25, 0.3, or larger. Fourth waveguide layer 970 and fifth waveguide layer 980 may have a same refractive index or different refractive indices. Multi-layer waveguide display 902 may achieve a more uniform replication of light having different colors and from different FOVs as described above with respect to FIG. 6B and FIG. 8B. The thicknesses and the refractive indices of first waveguide layer 912, second waveguide layer 952, third waveguide layer 962, fourth waveguide layer 970, and fifth waveguide layer 980 may be selected based on the desired performance.

In various embodiments, the multi-layer waveguide displays disclosed herein may include two or more waveguide layers, such as three, four, five, or more layers. In some embodiments, the low-index waveguide layers may be on a same side of the input and output gratings, and the refractive indices of the two or more waveguide layers may be the highest at one side of the layer stack and then gradually decrease towards the other side of the layer stack. For example, multi-layer waveguide display 900 may not include either second waveguide layer 950 or third waveguide layer 960, while multi-layer waveguide display 902 may not include either waveguide layers 962 and 980 or waveguide layers 952 and 970. In some embodiments, the low-index waveguide layers may be on opposing sides of the input and output gratings, and the refractive indices of the two or more waveguide layers may be the highest at the center of the layer stack and may gradually decrease towards two opposite sides of the layer stack. In some embodiments, the refractive index profile of the waveguide layer stack may be symmetrical and have the highest value at the center as shown in FIG. 9B. In some embodiments, the refractive index profile of the waveguide layer stack may not be symmetrical with respect to the center of the waveguide layer stack.

The multiple waveguide layers having different refractive indices and thicknesses (e.g., from about 100 to about 600 μm) may need to be flat and have a low total thickness variation (e.g., <1 μm) and a low surface roughness (e.g., with a root mean squared areal roughness less than about 1 nm). The multiple waveguide layers may need to have low transmissive haze, and would not need to be polished. It may also be desirable that the multiple waveguide layers be made at low temperatures, such as at the room temperature. Thus, it can be challenging to fabricate the multiple waveguide layers on a substrate that has grating couplers etched thereon. In some implementations, multi-layer waveguides may be made by bonding multiple low-index substrates or layers to a substrate (e.g., a SiC substrate), by lamination, by slot-die coating, by chemical vapor deposition (e.g., plasma-enhanced chemical vapor deposition (PECVD)), or the like. However, these techniques may not be able to achieve the desired characteristics of the multiple waveguide layers described above.

According to certain embodiments, the multi-layer waveguide may be made using inkjet 3-D printing techniques. During the inkjet 3-D printing, a large number of small drops of a resin material (referred to as an ink) may be deposited on a substrate having input and output gratings formed thereon. The large number (e.g., a two-dimensional array) of small drops of the resin material may form a uniform thin layer (e.g., less than about 20 μm or less than about 10 μm), which may be cross-linked, for example, through ultraviolet (UV) curing or thermal treatment. Another thin layer of the resin material may then be deposited on the cross-linked thin layer and be cross-linked, until a desired total thickness of a waveguide layer is achieved. Another waveguide layer having a different (e.g. lower) refractive index may be printed on the previously printed waveguide layer that may have a higher refractive index or may be printed on an opposite side of the substrate.

In some embodiments, the materials (inks) used for the 3-D printing may include a base resin that includes at least one actinic light curable moiety of acrylate, epoxide, vinyl, thiols, allyls, vinylether, allylethers, epoxy acrylates, urethane acrylates, polyester acrylates, or a combination thereof. The materials used for the 3-D printing may also include a photoinitiator, such as a photo radical generator (PRG) or a photo acid generator. The materials can be tuned to have the desired refractive index. For example, high-index nanoparticles may be added to the resin material to tune the refractive index of the resin material. The nanoparticles used to tune the refractive index of the resin material may include, for example, metal oxides such as titanium oxide, zirconium oxide, hafnium oxide, tungsten oxide, zinc tellurium, gallium phosphide, a derivative of any of the preceding materials, or any combination of these materials.

Using the techniques disclosed herein, transparent low index layers each with a thickness of about 10 microns to about a few hundred microns, low total thickness variation (TTV), and low surface roughness can be deposited on selected areas of interest, such as an entire surface of the base substrate or only on top of some functional devices (e.g., the output gratings). The thicknesses and thickness variations of the layers may be more precisely controlled. The process temperature can be below 250° C., such as room temperatures. As such, the bowing of the wafer may be low. Only one dicing step may be needed to form individual devices from a base substrate. There is no need to dice both the base substrate and additional substrates/layers and then bond them. The materials used for the 3-D printing can have a lower density (e.g., about 1.25 g/cm³) than, for example, the SiC substrate (e.g., about 3.21 g/cm³), fused silica (e.g., about 2.17 g/cm³), or other substrate materials. Thus, the waveguide display may have a lighter weight. The materials used for the printing can be tuned to have the desired refractive index. For example, high-index nanoparticles may be added to the resin material to tune the refractive index of the resin material, for example, from about 1.45 or lower to about 2.0 or higher, such as between about 1.5 and about 1.8.

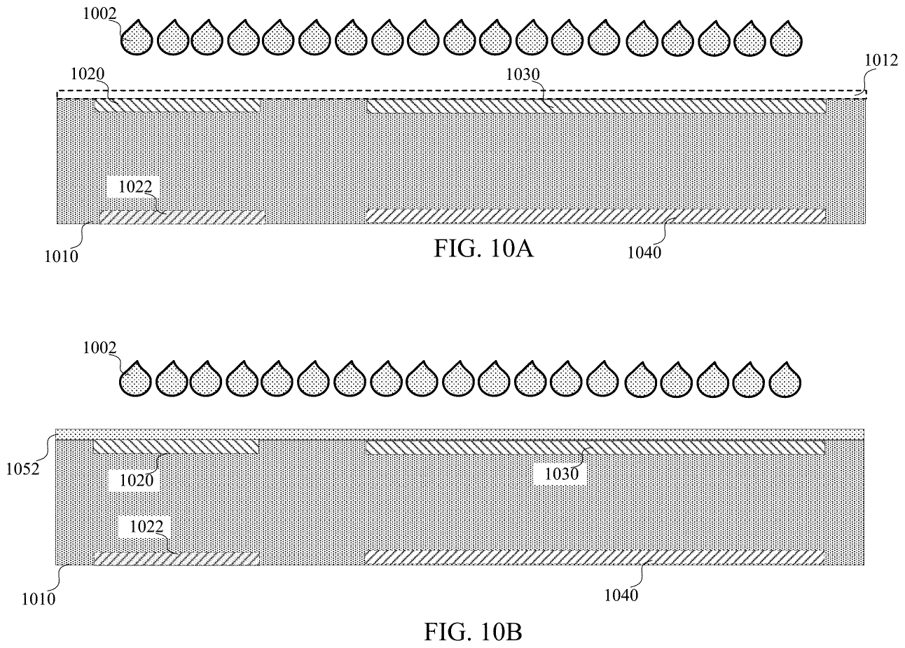

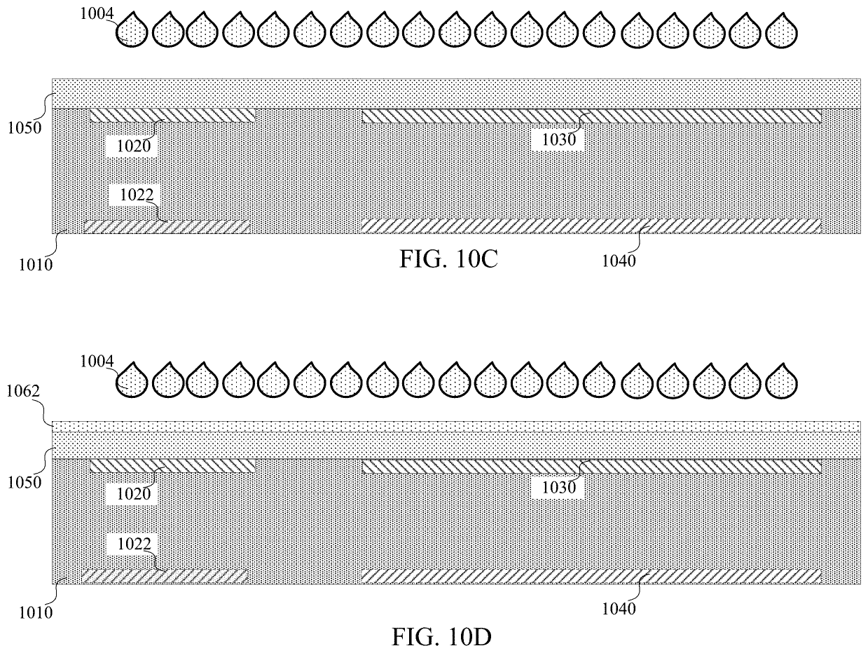

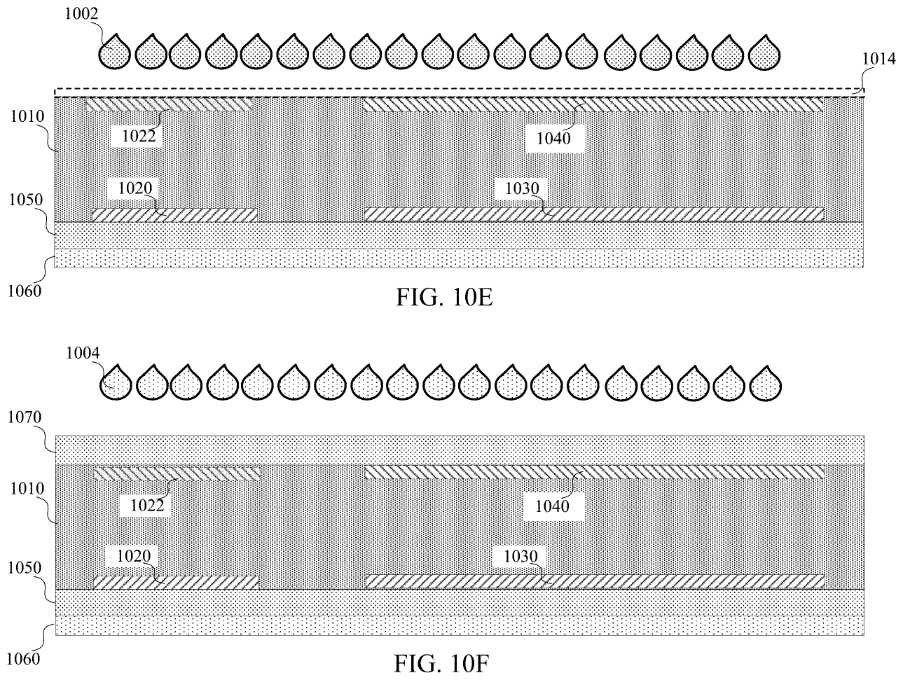

FIGS. 10A-10F illustrate an example of a method of fabricating a multi-layer waveguide display according to certain embodiments. FIG. 10A shows that a first waveguide layer 1010 (e.g., a wafer of glass, silicon, silicon nitride, silicon carbide, LiNbO₃, TiO₂, GaN, AlN, CVD diamond, or ZnS) may include one or more input gratings 1020 and 1022 and one or more output gratings 1030 and 1040 formed thereon as described above. Input gratings 1020 and 1022 and output gratings 1030 and 1040 may include slanted or vertical surface-relief gratings and may each include an overcoat layer filling the grating grooves. First waveguide layer 1010 may have a first refractive index, and the overcoat layer may have a second refractive index that may be higher or lower than the first refractive index to cause a large refractive index modulation. In some embodiments, the overcoat layers may be formed on input gratings 1020 and 1022 and output gratings 1030 and 1040 by depositing small droplets of overcoat materials on top of input gratings 1020 and 1022 and output gratings 1030 and 1040, and curing the overcoat materials.

As illustrated, thousands or millions of droplets 1002 of a first ink material having a desired refractive index as described above may be deposited on areas of interest on first waveguide layer 1010. The first ink material may include a base resin that includes at least one actinic light curable moiety of acrylate, epoxide, vinyl, thiols, allyls, vinylether, allylethers, epoxy acrylates, urethane acrylates, polyester acrylates, or a combination thereof. The first ink material may also include a photoinitiator, such as a photo radical generator (PRG) or a photo acid generator. The first ink material may also include high-index nanoparticles for tuning the refractive index of the first ink material. The high-index nanoparticles may include, for example, metal oxides such as titanium oxide, zirconium oxide, hafnium oxide, tungsten oxide, zinc tellurium, gallium phosphide, a derivative of any of the preceding materials, or any combination of these materials. The droplets of the first ink material may form a uniform thin layer (e.g., less than about 20 μm or less than about 10 μm) of the first ink material in the areas of interest. The uniform thin layer of the first ink material may be coupled to the first waveguide layer 1010 and the gratings formed thereon through covalent bonds. In some embodiments, before depositing droplets 1002 of the first ink material, an optional adhesion promoting layer 1012 may be deposited on first waveguide layer 1010 by, for example, inkjetting or spin coating. Adhesion promoting layer 1012 may help to improve the bonding of the first ink material to first waveguide layer 1010. Adhesion promoting layer 1012 may include, for example, epoxy acrylate, silane acrylate, silane epoxy, diacrylate, diepoxy, or a combination thereof. In some embodiments, adhesion promoting layer 1012 may include a thin SiO₂ layer or another inorganic material layer formed on first waveguide layer 1010 by, for example, physical vapor deposition (PVD) or evaporation. Adhesion promoting layer 1012 may have a thickness less than a few microns or less than about 1 μm.

FIG. 10B shows that the uniform thin layer of the first ink material may be cured by UV light or heat to cross-link the monomers or moieties to form polymers or large polymers in a sub-layer 1052 of a second waveguide layer 1050. Another set of droplets 1002 of the first ink material may be deposited on sub-layer 1052, and may be cross-linked by, for example, UV curing, to form another sub-layer of second waveguide layer 1050. The processes of depositing and curing the uniform thin layers of the first ink material may be performed repeatedly to achieve the desired thickness (e.g., about 100 to about 600 μm or thicker) of second waveguide layer 1050.

FIG. 10C shows that after second waveguide layer 1050 having the desired uniform thickness is formed on first waveguide layer 1010, a set of droplets 1004 of a second ink material having a lower refractive index (e.g., with the same base resin but lower concentration of high-index nanoparticles) may be deposited on second waveguide layer 1050. The droplets may form a uniform thin layer (e.g., less than about 20 μm or less than about 10 μm) of the second ink material in the areas of interest.

FIG. 10D shows that the uniform thin layer of the second ink material may be cured by UV light to cross-link the monomers or moieties to form polymers or large polymers in a sub-layer 1062 of a third waveguide layer 1060. Another set of droplets 1004 of the second ink material may be deposited on sub-layer 1062, and may be cross-linked by, for example, UV curing, to form another sub-layer of third waveguide layer 1060. The processes of depositing and curing the uniform thin layer of the second ink material may be performed repeatedly to achieve the desired thickness (e.g., about 100 μm or thicker) of third waveguide layer 1060.

FIG. 10E shows that the layer stack including first waveguide layer 1010, second waveguide layer 1050, and third waveguide layer 1060 may be flipped over, and a set of droplets 1002 of the first ink material may be deposited on areas of interest on the surface of first waveguide layer 1010 opposing second waveguide layer 1050. The droplets may form a uniform thin layer (e.g., less than about 20 μm or less than about 10 μm) of the first ink material. The uniform thin layer of the first ink material may be cured by UV light to cross-link the monomers or moieties to form polymers or large polymers in a sub-layer of a fourth waveguide layer 1070. Another set of droplets 1002 of the first ink material may be deposited on the sub-layer, and may be cross-linked by, for example, UV curing, to form another sub-layer of fourth waveguide layer 1070. The processes of depositing and curing the uniform thin layer of the first ink material may be performed repeatedly to achieve the desired thickness (e.g., about 100 μm or thicker) of fourth waveguide layer 1070. In some embodiments, before depositing droplets 1002 of the first ink material on the surface of first waveguide layer 1010 opposing second waveguide layer 1050, an optional adhesion promoting layer 1014 may be deposited on the surface of first waveguide layer 1010 by, for example, inkjetting or spin coating. Adhesion promoting layer 1014 may help to improve the bonding of the first ink material to first waveguide layer 1010. Adhesion promoting layer 1014 may include, for example, epoxy acrylate, silane acrylate, silane epoxy, diacrylate, diepoxy, or a combination thereof. In some embodiments, adhesion promoting layer 1014 may include a thin SiO₂ layer or another inorganic material layer formed on the surface of first waveguide layer 1010 by, for example, PVD or evaporation. Adhesion promoting layer 1014 may have a thickness less than a few microns or less than about 1 μm.

FIG. 10F shows that a set of droplets 1004 of the second ink material may be deposited on fourth waveguide layer 1070. The droplets may form a uniform thin layer (e.g., less than about 20 μm or less than about 10 μm) of the second ink material in areas of interest. The uniform thin layer of the second ink material may be cured by UV light to cross-link the monomers or moieties to form polymers or large polymers in a sub-layer of a fifth waveguide layer (not shown in FIG. 10F) that may be similar to third waveguide layer 1060. The processes of depositing and curing the second ink material may be performed repeatedly to achieve the desired thickness (e.g., about 100 μm or thicker) of the fifth waveguide layer.

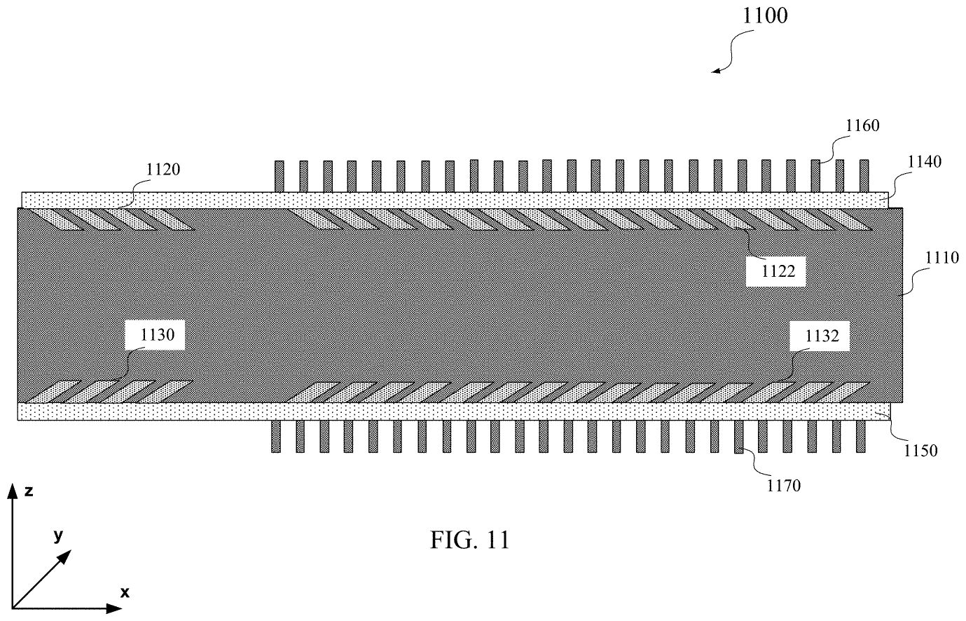

FIG. 11 illustrates an example of a waveguide display 1100 including multiple waveguide layers and dual-side antireflection structures according to certain embodiments. Waveguide display 1100 may include a first waveguide layer 1110 (e.g., a substrate of glass, silicon, silicon nitride, silicon carbide, LiNbO₃, TiO₂, GaN, AlN, CVD diamond, or ZnS). An input grating 1120 (e.g., a slanted or vertical surface relief grating) may be fabricated in first waveguide layer 1110 or in a grating material layer deposited on the top surface of first waveguide layer 1110. In some embodiments, a second input grating 1130 (e.g., a slanted or vertical surface relief grating) may be fabricated in first waveguide layer 1110 or in a grating material layer deposited on the bottom surface of first waveguide layer 1110. Waveguide display 1100 may also include one or more output gratings, such as an output grating 1122 formed in first waveguide layer 1110 or in the grating material layer deposited on the top surface of first waveguide layer 1110, and/or an output grating 1132 formed in first waveguide layer 1110 or in the grating material layer deposited on the bottom surface of first waveguide layer 1110. Gratings 1120, 1130, 1122 and 1132 may include surface-relief gratings or holographic gratings, and may be vertical or slanted gratings. When the input gratings and output gratings are surface-relief gratings, each of the gratings may be coated with an overcoat layer that fills the grating grooves and has a refractive index different from the refractive index of the grating ridges. In some embodiments, one or more of the input gratings and output gratings may each have a variable grating period, a variable duty cycle, a variable slant angle, and/or a variable etch depth. In some embodiments, one or more of the input gratings and output gratings may each include a two-dimensional grating that has a variable grating period, a variable duty cycle, a variable slant angle, and/or a variable etch depth along two directions of the two-dimensional grating.

Waveguide display 1100 may further include one or more waveguide layers 1140 and 1150 formed on opposite surfaces of waveguide display 1100, such as on output gratings 1122 and 1132 and/or input gratings 1120 and 1130, using the inkjet 3-D printing techniques disclosed herein. Waveguide layers 1140 and 1150 may each have a lower refractive index than first waveguide layer 1110, and may have a thickness about a few hundred microns, such as about 100 μm or thicker. As described above, in some embodiments, more waveguide layers with lower refractive indices may be formed on waveguide layers 1140 and 1150 using the inkjet 3-D printing techniques described above.

In the illustrated example, antireflection layers 1160 and 1170 may be formed on waveguide layers 1140 and 1150, respectively. Antireflection layers 1160 and 1170 may include periodic pillar structures to reduce reflections of visible light at the top and bottom surfaces of waveguide display 1100, including light entering or exiting waveguide display 1100, ambient light for see-through view, and ambient light from grazing angles outside of the see-through field of view of waveguide display 1100. Antireflection layers 1160 and 1170 may work for light in a broad wavelength range and a large angular range, and may not result in see-through haze due to, for example, small grating periods such that visible light diffracted by antireflection layer 1160 or 1170 may have a large diffraction angle and thus may not reach user's eyes.

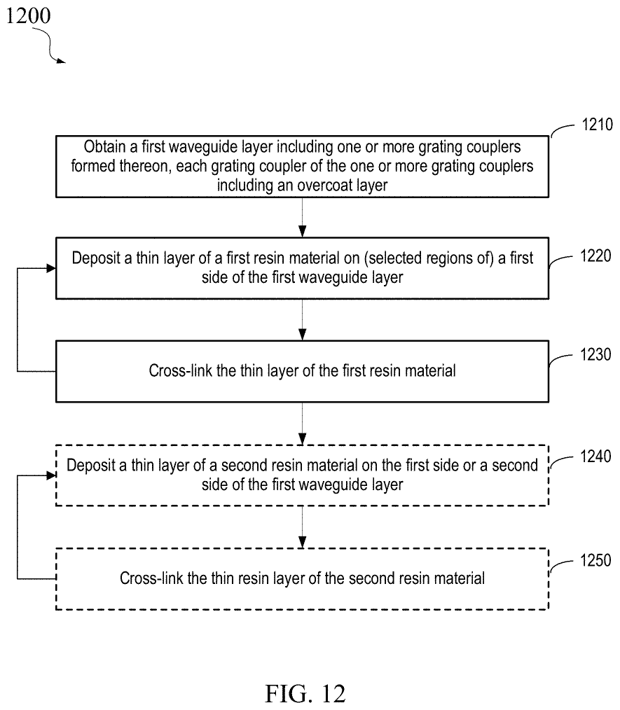

FIG. 12 includes a flowchart 1200 illustrating an example of a process for fabricating a multi-layer waveguide display using an additive manufacturing process according to certain embodiments. The operations described in flowchart 1200 are for illustration purposes only and are not intended to be limiting. In various implementations, modifications may be made to flowchart 1200 to add additional operations, to omit some operations, or to change the order of the operations. The operations described in flowchart 1200 may be performed by, for example, one or more fabrication systems, such as a photolithography system, a dry or wet etching (e.g., ion beam etching (IBE), plasma etching (PE), or reactive ion etching (RIE)) system, an inkjet 3-D printing system, and the like.

At block 1210, a first waveguide layer including one or more grating couplers formed thereon may be obtained, each grating coupler of the one or more grating couplers including an overcoat layer. The one or more grating couplers may be formed on the first waveguide layer or a grating material layer on the first waveguide layer. The first waveguide layer may include, for example, glass, silicon, silicon nitride, silicon carbide, LiNbO₃, TiO₂, GaN, AlN, SiC, CVD diamond, ZnS, or any other suitable materials. The one or more grating couplers may be on one or two surfaces of the first waveguide layer and may include slanted or vertical surface-relief gratings. The one or more grating couplers may include one or more input grating couplers for coupling display light into the first waveguide layer, and one or more output grating couplers for coupling display light out of the first waveguide layer. The one or more grating couplers may be etched in the first waveguide layer or the grating material layer. The etching may be, for example, vertical or slanted dry etching using ion or plasma beams and an etch mask. The etch time and slant angle may be controlled to achieve the desired grating depth and slant angle of the gratings. In some embodiments, one or more of the input gratings and output gratings may each have a variable grating period, a variable duty cycle, a variable slant angle, and/or a variable etch depth. In some embodiments, one or more of the input gratings and output gratings may each include a two-dimensional grating that has a variable grating period, a variable duty cycle, a variable slant angle, and/or a variable etch depth along two directions of the two-dimensional grating.

The overcoat layer may be formed on the etched gratings to fill the grating grooves. The overcoat layer may be characterized by a refractive index different from a refractive index of the first waveguide layer. For example, in some embodiments, a lower refractive index material, such as silicon oxide, alumina, porous silica, or fluorinated low index monomer (or polymer), may be used to fill the grating grooves. In some embodiments, a high refractive index material, such as Hafnia, Titania, Tantalum oxide, Tungsten oxide, Zirconium oxide, Gallium sulfide, Gallium nitride, Gallium phosphide, silicon, or a high refractive index polymer, may be used to fill the grating grooves. In some embodiments, the overcoat layer may be formed by depositing small droplets of overcoat materials on top of the grating coupler and curing the overcoat materials.

In some embodiments, an adhesion promoting layer may be deposited on a first side (and/or a second side) of the first waveguide layer by, for example, inkjetting or spin coating. The adhesion promoting layer may help to improve the bonding of resin materials to the first waveguide layer. The adhesion promoting layer may include, for example, epoxy acrylate, silane acrylate, silane epoxy, diacrylate, diepoxy, or a combination thereof. In some embodiments, the adhesion promoting layer may include a thin SiO₂ layer or another inorganic material layer formed on the first side (and/or the second side) of the first waveguide layer by, for example, PVD or evaporation. The adhesion promoting layer may have a thickness less than a few microns or less than about 1 μm.

At block 1220, a thin layer of a first resin may be deposited on a first side of the first waveguide layer. Depositing the thin layer of the first resin material on the first waveguide layer may include dispensing a two-dimensional array of droplets of the first resin material on the overcoat layer or selected regions of the first waveguide layer. The first resin material may include an actinic light curable moiety. The actinic light curable moiety may include acrylate, epoxide, vinyl, thiols, allyls, vinylether, allylethers, epoxy acrylates, urethane acrylates, polyester acrylates, or a combination thereof. The first resin material may also include a photoinitiator. The first resin material may further include nanoparticles of, for example, titanium oxide, zirconium oxide, hafnium oxide, tungsten oxide, zinc tellurium, gallium phosphide, or a combination thereof. The refractive index of the first resin material may be between about 1.45 and about 2.0. such as between about 1.5 and about 1.7. The first resin material may have a density less than about 2 g/cm³, such as less than about 1.5 g/cm³ (e.g., about 1.25 g/cm³).

At block 1230, the thin layer of the first resin material may be cross-linked to form polymers by, for example, electromagnetic radiation (e.g., UV light curing) or thermal treatment. The thin layer of the first resin material may have a thickness, for example, less than about 20 μm or less than about 10 μm. Operations at blocks 1220 and 1230 may be repeated in a plurality of process cycles to form a second waveguide layer that has a desired thickness, such as greater than about 100 μm or greater than about 200 μm. A root mean squared areal roughness of a surface of the second waveguide layer may be less than about 1 nm. A total thickness variation of the second waveguide layer may be less than about 1 μm.

Optionally, at block 1240, a thin layer of a second resin material may be deposited on the second waveguide layer or on a second side of the first waveguide layer. The second resin material may be characterized by a refractive index that is the same as or lower than the refractive index of the first resin material. In some embodiments, the second resin material may include acrylate, epoxide, vinyl, thiols, allyls, vinylether, allylethers, epoxy acrylates, urethane acrylates, polyester acrylates, or a combination thereof. The second resin material may also include a photoinitiator. The second resin material may further include nanoparticles of, for example, titanium oxide, zirconium oxide, hafnium oxide, tungsten oxide, zinc tellurium, gallium phosphide, or a combination thereof. The refractive index of the second resin material may be tuned by changing the concentration of the nanoparticles in the second resin material.

Optionally, at block 1250, the thin resin layer of the second resin material may be cross-linked by, for example, electromagnetic radiation (e.g., UV light curing) or thermal treatment. The thin layer of the second resin material may have a thickness, for example, less than about 20 μm or less than about 10 μm. Operations at blocks 1240 and 1250 may be repeated in a plurality of process cycles to form a third waveguide layer that has a desired thickness, such as greater than about 100 μm or greater than about 200 μm. A root mean squared areal roughness of a surface of the third waveguide layer may be less than about 1 nm. A total thickness variation of the third waveguide layer may be less than about 1 μm.

In some embodiments, a first waveguide layer stack may be formed on the first side of the first waveguide layer. The first waveguide layer stack may include one or more polymer layers, where each of the one or more polymer layers may be characterized by a respective refractive index lower than the refractive index of the first waveguide layer. In some embodiments, the first waveguide layer stack may be characterized by a refractive index profile that decreases with an increase in a distance of the first waveguide layer stack from the first waveguide layer. In some embodiments, a second waveguide layer stack may be formed on the second side of the first waveguide layer. The second waveguide layer stack may include one or more polymer layers, where each of the one or more polymer layers may be characterized by a respective refractive index lower than the refractive index of the first waveguide layer. In some embodiments, the second waveguide layer stack may be characterized by a refractive index profile that decreases with an increase in a distance of the second waveguide layer stack from the first waveguide layer. In some embodiments, an antireflection layer as described above with respect to FIG. 11 may be formed on each of the first waveguide layer stack and the second waveguide layer stack.

Embodiments of the invention may include or be implemented in conjunction with an artificial reality system. Artificial reality is a form of reality that has been adjusted in some manner before presentation to a user, which may include, for example, a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

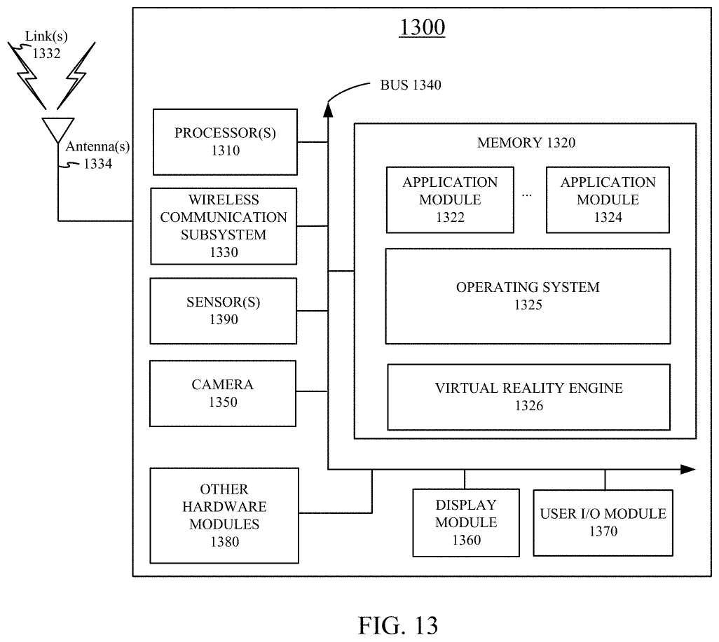

FIG. 13 is a simplified block diagram of an electronic system 1300 of an example of a near-eye display (e.g., HMD device) for implementing some of the examples disclosed herein. Electronic system 1300 may be used as the electronic system of an HMD device or other near-eye displays described above. In this example, electronic system 1300 may include one or more processor(s) 1310 and a memory 1320. Processor(s) 1310 may be configured to execute instructions for performing operations at a number of components, and can be, for example, a general-purpose processor or microprocessor suitable for implementation within a portable electronic device. Processor(s) 1310 may be communicatively coupled with a plurality of components within electronic system 1300. To realize this communicative coupling, processor(s) 1310 may communicate with the other illustrated components across a bus 1340. Bus 1340 may be any subsystem adapted to transfer data within electronic system 1300. Bus 1340 may include a plurality of computer buses and additional circuitry to transfer data.

Memory 1320 may be coupled to processor(s) 1310. In some embodiments, memory 1320 may offer both short-term and long-term storage and may be divided into several units. Memory 1320 may be volatile, such as static random access memory (SRAM) and/or dynamic random access memory (DRAM) and/or non-volatile, such as read-only memory (ROM), flash memory, and the like. Furthermore, memory 1320 may include removable storage devices, such as secure digital (SD) cards. Memory 1320 may provide storage of computer-readable instructions, data structures, program modules, and other data for electronic system 1300. In some embodiments, memory 1320 may be distributed into different hardware modules. A set of instructions and/or code might be stored on memory 1320. The instructions might take the form of executable code that may be executable by electronic system 1300, and/or might take the form of source and/or installable code, which, upon compilation and/or installation on electronic system 1300 (e.g., using any of a variety of generally available compilers, installation programs, compression/decompression utilities, etc.), may take the form of executable code.

In some embodiments, memory 1320 may store a plurality of application modules 1322 through 1324, which may include any number of applications. Examples of applications may include gaming applications, conferencing applications, video playback applications, or other suitable applications. The applications may include a depth sensing function or eye tracking function. Application modules 1322-1324 may include particular instructions to be executed by processor(s) 1310. In some embodiments, certain applications or parts of application modules 1322-1324 may be executable by other hardware modules 1380. In certain embodiments, memory 1320 may additionally include secure memory, which may include additional security controls to prevent copying or other unauthorized access to secure information.

In some embodiments, memory 1320 may include an operating system 1325 loaded therein. Operating system 1325 may be operable to initiate the execution of the instructions provided by application modules 1322-1324 and/or manage other hardware modules 1380 as well as interfaces with a wireless communication subsystem 1330 which may include one or more wireless transceivers. Operating system 1325 may be adapted to perform other operations across the components of electronic system 1300 including threading, resource management, data storage control and other similar functionality.

Wireless communication subsystem 1330 may include, for example, an infrared communication device, a wireless communication device and/or chipset (such as a Bluetooth® device, an IEEE 802.11 device, a Wi-Fi device, a WiMax device, or cellular communication facilities), and/or similar communication interfaces. Electronic system 1300 may include one or more antennas 1334 for wireless communication as part of wireless communication subsystem 1330 or as a separate component coupled to any portion of the system. Depending on desired functionality, wireless communication subsystem 1330 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 1330 may permit data to be exchanged with a network, other computer systems, and/or any other devices described herein. Wireless communication subsystem 1330 may include a means for transmitting or receiving data, such as identifiers of HMD devices, position data, a geographic map, a heat map, photos, or videos, using antenna(s) 1334 and wireless link(s) 1332. Wireless communication subsystem 1330, processor(s) 1310, and memory 1320 may together comprise at least a part of one or more of a means for performing some functions disclosed herein.

Embodiments of electronic system 1300 may also include one or more sensors 1390. Sensor(s) 1390 may include, for example, an image sensor, an accelerometer, a pressure sensor, a temperature sensor, a proximity sensor, a magnetometer, a gyroscope, an inertial sensor (e.g., a module that combines an accelerometer and a gyroscope), an ambient light sensor, or any other similar module operable to provide sensory output and/or receive sensory input, such as a depth sensor or a position sensor. For example, in some implementations, sensor(s) 1390 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 1300 may include a display module 1360. Display module 1360 may be a near-eye display, and may graphically present information, such as images, videos, and various instructions, from electronic system 1300 to a user. Such information may be derived from one or more application modules 1322-1324, virtual reality engine 1326, one or more other hardware modules 1380, a combination thereof, or any other suitable means for resolving graphical content for the user (e.g., by operating system 1325). Display module 1360 may use liquid crystal display (LCD) technology, light-emitting diode (LED) technology (including, for example, OLED, ILED, μLED, AMOLED, or TOLED), light emitting polymer display (LPD) technology, or some other display technology.

Electronic system 1300 may include a user input/output module 1370. User input/output module 1370 may allow a user to send action requests to electronic system 1300. An action request may be a request to perform a particular action. For example, an action request may be to start or end an application or to perform a particular action within the application. User input/output module 1370 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 1300. In some embodiments, user input/output module 1370 may provide haptic feedback to the user in accordance with instructions received from electronic system 1300. For example, the haptic feedback may be provided when an action request is received or has been performed.

Electronic system 1300 may include a camera 1350 that may be used to take photos or videos of a user, for example, for tracking the user's eye position. Camera 1350 may also be used to take photos or videos of the environment, for example, for VR, AR, or MR applications. Camera 1350 may include, for example, a complementary metal-oxide-semiconductor (CMOS) image sensor with a few millions or tens of millions of pixels. In some implementations, camera 1350 may include two or more cameras that may be used to capture 3-D images.

In some embodiments, electronic system 1300 may include a plurality of other hardware modules 1380. Each of other hardware modules 1380 may be a physical module within electronic system 1300. While each of other hardware modules 1380 may be permanently configured as a structure, some of other hardware modules 1380 may be temporarily configured to perform specific functions or temporarily activated. Examples of other hardware modules 1380 may include, for example, an audio output and/or input module (e.g., a microphone or speaker), a near field communication (NFC) module, a rechargeable battery, a battery management system, or a wired/wireless battery charging system. In some embodiments, one or more functions of other hardware modules 1380 may be implemented in software.

In some embodiments, memory 1320 of electronic system 1300 may also store a virtual reality engine 1326. Virtual reality engine 1326 may execute applications within electronic system 1300 and receive position information, acceleration information, velocity information, predicted future positions, or some combination thereof of the HMD device from the various sensors. In some embodiments, the information received by virtual reality engine 1326 may be used for producing a signal (e.g., display instructions) to display module 1360. For example, if the received information indicates that the user has looked to the left, virtual reality engine 1326 may generate content for the HMD device that mirrors the user's movement in a virtual environment. Additionally, virtual reality engine 1326 may perform an action within an application in response to an action request received from user input/output module 1370 and provide feedback to the user. The provided feedback may be visual, audible, or haptic feedback. In some implementations, processor(s) 1310 may include one or more graphic processing units (GPUs) that may execute virtual reality engine 1326.

In various implementations, the above-described hardware and modules may be implemented on a single device or on multiple devices that can communicate with one another using wired or wireless connections. For example, in some implementations, some components or modules, such as GPUs, virtual reality engine 1326, and applications (e.g., tracking application), may be implemented on a console separate from the head-mounted display device. In some implementations, one console may be connected to or support more than one HMD.

In alternative configurations, different and/or additional components may be included in electronic system 1300. Similarly, functionality of one or more of the components can be distributed among the components in a manner different from the manner described above. For example, in some embodiments, electronic system 1300 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets), or both. Further, connection to other computing devices such as network input/output devices may be employed.

With reference to the appended figures, components that can include memory can include non-transitory machine-readable media. The term “machine-readable medium” and “computer-readable medium,” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or a combination of A, B, and C, such as AB, AC, BC, AA, ABC, AAB, or AABBCCC.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A method of fabricating a multi-layer waveguide display, the method comprising:
obtaining a first waveguide layer including one or more grating couplers formed thereon, each grating coupler of the one or more grating couplers including an overcoat layer that fills grating grooves of the grating coupler and is characterized by a refractive index different from a refractive index of the first waveguide layer; and
forming a second waveguide layer on a first side of the first waveguide layer in a plurality of process cycles, each process cycle of the plurality of process cycles comprising:
depositing a thin layer of a first resin material on the first waveguide layer, the first resin material characterized by a refractive index lower than the refractive index of the first waveguide layer; and
cross-linking the thin layer of the first resin material to form a sublayer of the second waveguide layer.

2. The method of claim 1, wherein depositing the thin layer of the first resin material on the first waveguide layer includes dispensing a two-dimensional array of droplets of the first resin material on the first waveguide layer.

3. The method of claim 1, wherein depositing the thin layer of the first resin material on the first waveguide layer includes depositing the thin layer of the first resin material on selected but not all regions of the first waveguide layer.

4. The method of claim 1, wherein cross-linking the thin layer of the first resin material comprises curing the thin layer of the first resin material by electromagnetic radiation or thermal treatment.

5. The method of claim 1, wherein the thin layer of the first resin material is characterized by a thickness equal to or less than 10 μm.

6. The method of claim 1, wherein the first resin material comprises:
an actinic light curable moiety that includes acrylate, epoxide, vinyl, thiols, allyls, vinylether, allylethers, epoxy acrylates, urethane acrylates, polyester acrylates, or a combination thereof; and
a photoinitiator.

7. The method of claim 1, wherein the first resin material comprises nanoparticles of titanium oxide, zirconium oxide, hafnium oxide, tungsten oxide, zinc tellurium, gallium phosphide, or a combination thereof.

8. The method of claim 1, further comprising, before forming the second waveguide layer on the first side of the first waveguide layer, forming an adhesion promoting layer on the first waveguide layer.

9. The method of claim 8, wherein forming the adhesion promoting layer on the first waveguide layer comprises:
inkjetting or spin coating, on the first waveguide layer, a layer of epoxy acrylate, silane acrylate, silane epoxy, diacrylate, diepoxy, or a combination thereof; or
depositing, on the first waveguide layer, a thin SiO₂ layer or another inorganic material layer.

10. The method of claim 1, further comprising forming a third waveguide layer on the second waveguide layer in a second plurality of process cycles, each process cycle of the second plurality of process cycles comprising:
depositing a thin layer of a second resin material on the second waveguide layer, the second resin material characterized by a refractive index lower than the refractive index of the first resin material; and
cross-linking the thin layer of the second resin material.

11. The method of claim 1, further comprising forming a third waveguide layer on a second side of the first waveguide layer opposing the first side in a second plurality of process cycles, each process cycle of the second plurality of process cycles comprising:
depositing a thin layer of a second resin material on the second side of the first waveguide layer, the second resin material characterized by a refractive index same as or lower than the refractive index of the first waveguide layer; and
cross-linking the thin layer of the second resin material.

12. A multi-layer waveguide display comprising:
a base waveguide layer;
one or more grating couplers on one or two surfaces of the base waveguide layer;
an overcoat layer on each grating coupler of the one or more grating couplers, wherein the overcoat layer fills grating grooves of the grating coupler and is characterized by a refractive index different from a refractive index of the base waveguide layer; and
a first waveguide layer stack on a first side of the base waveguide layer, the first waveguide layer stack including one or more polymer layers, wherein each of the one or more polymer layers is characterized by a respective refractive index lower than the refractive index of the base waveguide layer.

13. The multi-layer waveguide display of claim 12, wherein the first waveguide layer stack is characterized by a refractive index profile that decreases with an increase in a distance of the first waveguide layer stack from the base waveguide layer.

14. The multi-layer waveguide display of claim 12, further comprising a second waveguide layer stack on a second side of the base waveguide layer opposing the first side, the second waveguide layer stack including a second set of one or more polymer layers, wherein each polymer layer of the second set of one or more polymer layers is characterized by a respective refractive index lower than the refractive index of the base waveguide layer.

15. The multi-layer waveguide display of claim 12, wherein the first waveguide layer stack is characterized by:
a thickness of each of the one or more polymer layers greater than 100 μm;
a total thickness variation of the first waveguide layer stack less than 1 μm;
a root mean squared areal roughness of a surface of the first waveguide layer stack less than 1 nm;
a refractive index of the first waveguide layer stack between 1.45 and 2.0;
a density less than about 2 g/cm³; or
a combination thereof.

16. The multi-layer waveguide display of claim 12, wherein the first waveguide layer stack includes acrylate, epoxide, vinyl, thiols, allyls, vinylether, allylethers, epoxy acrylates, urethane acrylates, polyester acrylates, or a combination thereof.

17. The multi-layer waveguide display of claim 12, wherein the first waveguide layer stack includes nanoparticles dispersed in the one or more polymer layers, the nanoparticles comprising nanoparticles of titanium oxide, zirconium oxide, hafnium oxide, tungsten oxide, zinc tellurium, gallium phosphide, or a combination thereof.

18. The multi-layer waveguide display of claim 12, wherein the one or more grating couplers are on two surfaces of the base waveguide layer and include slanted surface-relief gratings.

19. The multi-layer waveguide display of claim 12, further comprising an antireflection layer on the first waveguide layer stack.

20. The multi-layer waveguide display of claim 12, further comprising an adhesion promoting layer between the base waveguide layer and the first waveguide layer stack, wherein the adhesion promoting layer includes:
a layer of epoxy acrylate, silane acrylate, silane epoxy, diacrylate, diepoxy, or a combination thereof; or
a thin layer of SiO₂ or another inorganic material.

21. The multi-layer waveguide display of claim 12, wherein the first waveguide layer stack is on selected but not all regions of the base waveguide layer.
